(19) United States
(12) Patent Application Publication
(10) Pub. No.: US 2009/0172627 A1
(43) Pub. Date: Jul. 2, 2009

(54) Design Structure for a Clock System for a Plurality of Functional Blocks

(75) Inventors: Jesse E. Craig, S. Burlington, VT (US); Stanley B. Stanski, Essex Junction, VT (US); Scott T. Vento, Santa Clara, CA (US)

Correspondence Address: DOWNS RACHLIN MARTIN PLLC, 199 MAIN ST, PO BO 190, BURLINGTON, VT, 05402-0190, US

(73) Assignee: INTERNATIONAL BUSINESS MACHINES CORPORATION, Armonk, NY (US)

(21) Appl. No.: 11/966,171

(22) Filed: Dec. 28, 2007

(51) Int. Cl. G06F 17/50

(52) U.S. Cl. 716/11

(57) ABSTRACT

A design structure for a clock system for a plurality of functional blocks designed using a method of reducing peak power that utilizes connectivity and/or timing information among a plurality of design partitions of an integrated circuit system to create a clock system that reduces peak power consumption across the system. The method used to create the design structure includes sorting the design partitions according to a connectivity model, a timing model, or both, and assigning interleaved clock signals as a function of the design partition ordering. The clock system is created as a function of the interleaved clock signals.

### FIELD OF THE INVENTION

The present invention generally relates to the field of integrated circuit design. In particular, the present invention is directed to a design structure for a clock system for a plurality of functional blocks designed using a method of reducing peak power consumption in an integrated circuit system.

### BACKGROUND

Peak power consumption, frequently expressed in terms of IR drop, is a growing concern in modern integrated circuit designs, such as, for example, designs using deep sub-micron technology. Peak power consumption can affect the performance of the integrated circuit, the robustness of the power grid, and the design time needed to close timing. In some cases, designs must be re-worked late in the design cycle to improve the robustness of weak points in the power grid. Presently, low power design methods are used to combat the power consumption problem. These methods reduce the number of switching events in the design, the overall capacitance of the paths, and the drive strength of standard cells to the minimum needed to close timing. Other methods, on the other hand, create dynamic power grids that change density based on the specific demand of the integrated circuit design.

### SUMMARY OF THE DISCLOSURE

In one implementation, a design structure embodied in a machine readable medium used in a design process for an integrated circuit system is provided. The design structure includes a plurality of functional blocks distributed among a plurality of design partitions and interconnected by a plurality of connection arcs; and a clock system, comprising: clock interleaving circuitry for interleaving a plurality of clock signals corresponding respectively to the plurality of design partitions, the clock interleaving circuitry configured as a function of a connectivity model of the plurality of connecting arcs or a timing model of the plurality of connecting arcs or both of the connectivity model and the timing model; and a plurality of timing paths connected to ones of the plurality of functional blocks in each of the plurality of design partitions so as to provide the plurality of clock signals to the plurality of functional blocks.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level schematic diagram of an integrated circuit (IC) system having a clock system designed in accordance with the present disclosure;

FIG. 2 is an exemplary timing diagram of clock signals within the clock system of FIG. 1;

FIG. 3 is a flow diagram illustrating a clock system design method that may be used to design a clock system, such as clock system of FIG. 1;

FIG. 4 is a connectivity/timing diagram for a plurality of design partition blocks of an exemplary IC system design;

FIG. 5 is a connectivity chart corresponding to the connectivity/timing diagram of FIG. 4;

FIG. 6 is a timing chart corresponding to the connectivity/timing diagram of FIG. 4; and

FIG. 7 is a flow diagram of a design process used in semiconductor design, manufacturing, and/or test.

### DETAILED DESCRIPTION

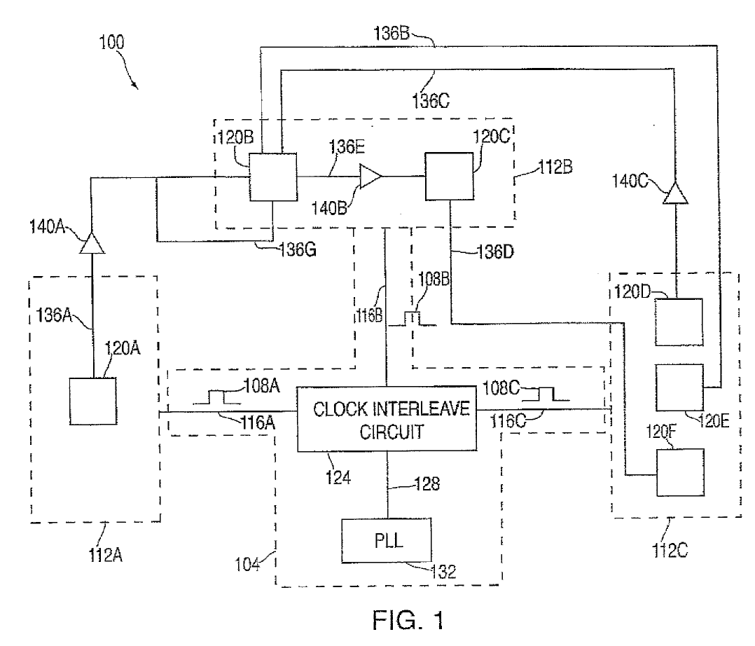

The present invention is directed to a design structure for a clock system for a plurality of functional blocks designed using a method of reducing peak power consumption in an integrated circuit system. Referring to the drawings, FIG. 1 illustrates an example 100 of an integrated circuit (IC) system that includes a clock circuit 104 made in accordance with the present invention. Clock circuit 104 ultimately generates a plurality of interleaved clock signals 108A-C that are transmitted to a plurality of design partitions, in this example partitions 112A-C, via a plurality of timing paths, here timing paths 116A-C. As those skilled in the art will appreciate, depending on the application IC system 100 may be located within a single chip, e.g., in the case of a microprocessor, application-specific integrated circuit (ASIC), system-on-chip (SOC), etc. or may comprise a plurality of chips and/or other discrete components, e.g., circuit board level busses, etc. Design partitions 112A-C may be selected and/or otherwise result from the design process for the IC system at issue. Consequently, each design partition, such as each partition 112A-C, can contain one or more functional components 120A-F as is suitable/necessary for the IC system under consideration. Examples of a functional component include, but are not limited to, a functional logic block, a memory, a processor, a computer chip, a communications bus (integrated and discrete), an ASIC and component thereof, an SOC and component thereof, a discrete IC component (e.g., a logic gate), and any combination thereof. That said, those ordinarily skilled in the art will readily recognize that the particular function(s) that system 100 provides is/are not material to the understanding of the present invention. Therefore, these functions are not described herein.

As elaborated more below, IC system 100 is particularly designed to cause functional components 120A-F of differing design partition 112A-C to receive clock signals 108A-C at differing times. In this example, this is accomplished by providing clock circuit 104 with an interleave circuit 124 that receives an input clock signal 128 from a clock signal source, here a phase-locked loop 132, and outputs interleaved clock signals 108A-C. Interleaved clock signals (e.g., clock signals 108A-C) are signals used to define time references for coordinating movement of data within a system (such as IC system 100) and to account for delays in the propagation of data signals (not illustrated) throughout the system. Examples of a clock interleave circuit suitable for use as interleave circuit 124 or other interleave circuit, include, without limitation, a static interleave circuit in which delays are set during design, a programmable interleave circuit in which delays are programmable after manufacturing, and any combination thereof. The clock signal source may be an on-chip or an off-chip source, depending on the application at issue.

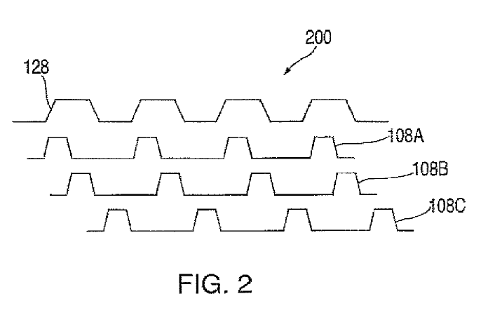

Referring to FIG. 2, and also to FIG. 1, FIG. 2 illustrates an exemplary timing diagram 200 for clock signals 108A-C and corresponding input clock signal 128 used by interleave circuit 124 to generate interleaved clock signals 108A-C. As illustrated in FIG. 2, interleaved clock signals 108A-C are clock signals derived from input clock signal 128 so as to have corresponding respective delays (including a delay of zero, which occurs in the case of clock signal 108A) and, optionally, modified waveforms relative to the waveform of the input clock signal. The staggered timings of interleaved clock signals 108A-C are designed to reduce peak power consumption by organizing design partitions 112A-C as a function of connectivity and/or timing considerations for communications interconnections (represented in FIG. 1 by interconnections 136A-E) as between the functional components 120A-F. Examples of various methods of determining the staggered timings of interleaved clock signals 108A-C and like clock signals, provided to partitions 112A-C and like partitions are described below. Depending on timing considerations, none, some or all of interconnections 136A-E may include one or more delay elements, such as delay element 140A-C for controllably causing the propagating of data through such interconnections to be delayed so as to effect the proper operation of the IC system, here IC system 100. Each delay element 140A-C may be any suitable delay element.

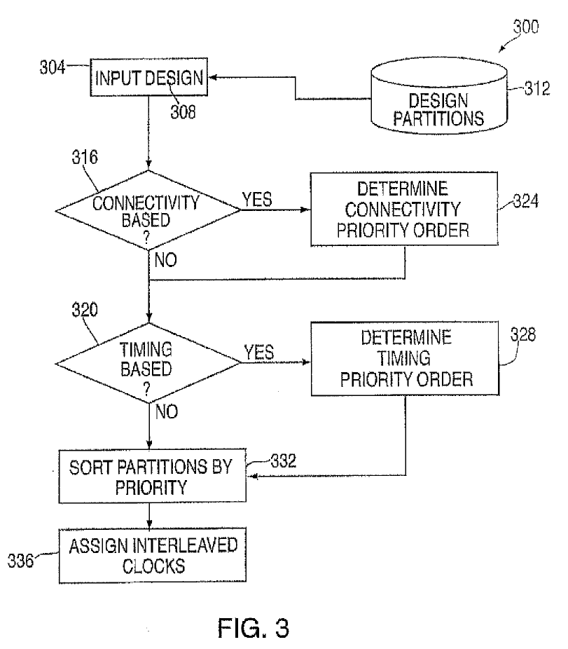

Referring next to FIG. 3, and also to FIG. 1, FIG. 3 illustrates an example 300 of a clock system design method that may be used to design a clock system of an IC system, such as clock system 104 of IC system 100 (FIG. 1). At step 304, an IC system design 308 (such as a design of IC system 100 of FIG. 1) is input into method 300. The IC system design may be considered to comprise a plurality of design partitions 312 (design partitions 112A-C in the example of FIG. 1). Design partitions 312 may be identified using any one or more of a variety of methods, such as identifying one or more of design partitions 312 based on a design hierarchy, identifying such partition(s) based on clock gating domain, and identifying such partition(s) based on a specified number of connections (e.g., connections 136A-E). In one specific example of method 300, design partitions 312 are identified so as to reduce the number of interconnections (e.g., interconnections 136A-E of FIG. 1) between the design partitions (e.g., partitions 112A-C of FIG. 1) while maximizing the number of interconnections within each partition, for example, between/among the functional components within that partition.

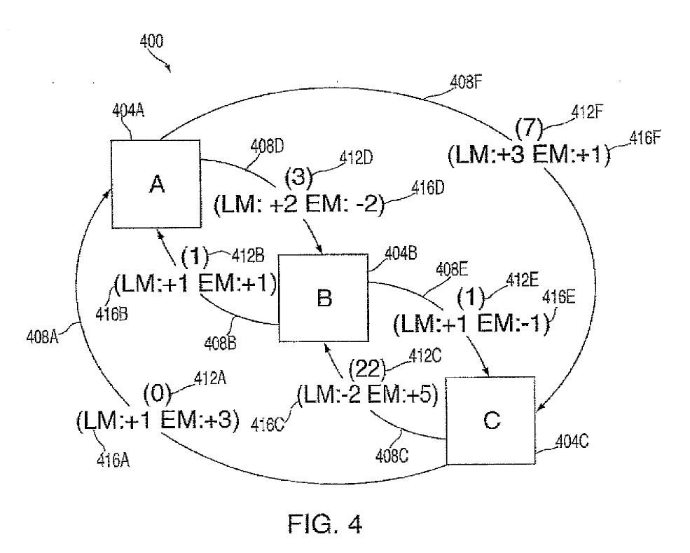

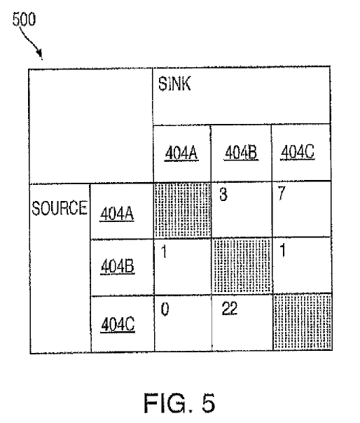

Once design 308 has been input, one or more clock system design models are applied to the design. Generally, a clock system design model is a tool for evaluating a specified aspect, or group of specified aspects, of a design. Examples of a clock system design model, include, without limitation, a connectivity model and a timing criticality model. A connectivity model may be used to determine connectivity priorities as a function of the number of data/communications connections between design partitions, here design partitions 312. A timing criticality model may be used to determine timing priorities as a function of the timing characteristics of the data/communications connections between design partitions. Further details of connectivity and timing criticality models are described below with reference to FIGS. 4-5.

Referring first to FIG. 4, this figure illustrates a connectivity/timing diagram 400 of an IC system design that includes a plurality of design partitions 404A-C interconnected with one another via connectivity arcs 408A-F. Each connectivity arc 408A-F simply represents a possible (though perhaps not actual) providing of information from a corresponding first design partition 404A-C (a/k/a a “source”) to a corresponding second one of design partitions (a/k/a a “sink”). Here, the directionality of the providing of information is represented by corresponding respective arrowheads. Since for the model it is initially assumed that each design partition 404A-C can provide information to each other design partition, this bi-directionality is represented by two connectivity arcs (such as connectivity arcs 408B, 408D in the case of design partitions 404A-B) that extend between each possible pair of design partitions. While connectivity arcs 408A-F represent potential communications connections, actual connections are represented by numerals 412A-F that correspond respectively to the number of actual connections that a given first design partition 404A-C makes with a given second one of design partitions. The number of connections is essentially driven by the functionality of the IC system represented in the design, the selection of design partitions, the function(s) of the functional blocks contained in the partitions, and the need for such blocks to communicate with one another.

Referring next to FIG. 5, and also to FIG. 4, FIG. 5 illustrates a connectivity chart 500 corresponding to connectivity/timing diagram 400 of FIG. 4. Connectivity chart 500 simply presents the connectivity information for a given design (or portion thereof) in tabular form. As readily seen from FIGS. 5 and 4, this connectivity information includes numerals 412A-F that represent the number of actual connections between the corresponding respective source and sink design partitions 404A-C.

Referring back to FIG. 4, each connection arc 408A-F also includes a timing margin information 416A-F. A timing margin is a timing characteristic for the corresponding respective connection arc 408A-F between design partitions 404A-C. Examples of a timing margin information 416A-F include, without limitation, late mode (LM) margins and early mode (EM) margins, and any combination thereof. A late mode margin (a/k/a “best case mode”) represents the optimal operation of an integrated circuit system, wherein no variations in temperature, manufacturing and voltage are taken into consideration. An early mode margin (a/k/a “worst case mode”) represents the slowest operation of an integrated circuit system, wherein the variations in temperature, manufacturing and voltage are considered. Late mode and early mode margins can be determined for connections 408A-F, for example, using a conventional static timing tool, such as the Einstimer static timing tool used by International Business Machines, Armonk, N.Y.

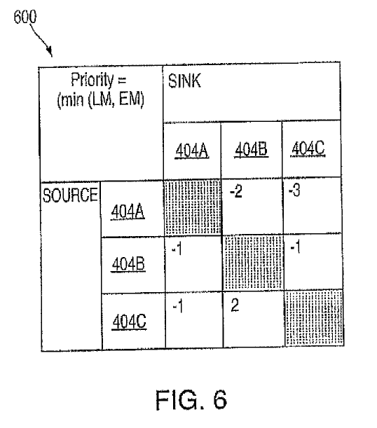

Referring now to FIG. 6, and also to FIG. 4, FIG. 6 illustrates a timing chart 600 corresponding to connectivity/timing diagram 400 of FIG. 4. Timing chart 600 presents timing priorities for the various connection arcs. In this example, each timing priority is the minimum value of the early mode and late mode margins for each connection arc 408A-F. In other embodiments, the timing priorities may be determined in another manner. For example, the timing priorities may be determined by the equation −LM+EM.

Referring back to FIG. 3, as mentioned above after design 308 has been entered into method 300, the method includes applying one, the other, or both of connectivity and timing models to the design. Correspondingly, method 300 may include steps 316, 320 for determining which one(s) of the connectivity and timing models will form the basis of the clock system design. More specifically, step 316 may determine whether or not the clock system design will be connectivity based, and step 320 may determine whether or not the clock system design will be timing based. As will be readily appreciated, each of steps 316, 320 may provide an answer in the affirmative, meaning that the clock system design may be both connectivity and timing based. This option is described in more detail below.

If at step 316 it is determined that clock system design is to be at least partially connectivity based, method 300 proceeds to step 324 at which the connectivity priorities are determined. This step prioritizes design partitions 312 according to their connectivity. In one example, design partitions 312 are prioritized so as to indicate the order in which each design partition receives a clock signal according to the number of connections in the corresponding respective connection arcs. For example, referring to connectivity chart 500 of FIG. 5, design partitions 404A-C may be organized into a structured priority list according to the number of connections. Such a structure priority list appears in Table I, below. The basis for this approach is the proposition that the greater the number of connections, the higher the priority of the corresponding connection arc 408A-F (FIG. 4) should be.

TABLE I

Ordered
Structure
List

| Connection Arc | Source | Sink |
|---|---|---|
| 408C | C | B |
| 408F | A | C |
| 408D | A | B |
| 408B | B | A |
| 408E | B | C |

In this example, the first listed connection arc in Table I, i.e., connection arc 408C (FIG. 4) between source 404C and sink 404B, has the highest priority because the connection has the highest number of connections, here 22. The second listed connection arc in Table I, i.e., connection arc 408F (FIG. 4) between source 404A and sink 404C, has the next highest priority because the connection has the next highest number of connections, i.e., 7. The remaining three connection arcs listed in Table I, i.e., connection arcs 408B, 408D-E (connection arc 408A has no connections) follow in the same manner.

Whether or not it was determined at step 316 that the clock timing design should be at least partially connectivity based, method 300 proceeds to step 320 where it is determined whether or not the clock timing design should be at least partially timing based. If so, method 300 proceeds to step 328 at which timing priorities are determined according to a timing criticality model. In one example, using timing chart 600 of FIG. 6 as an example, the timing priorities in timing chart 600 may be used to create an ordered structure list that organizes connectivity arcs 404A-F (FIG. 4) from highest to lowest priority based on the timing characteristics of the connections between design partitions. Such an ordered structure list is illustrated below in Table II.

TABLE II

Ordered
Structure
List

| Connection Arc | Source | Sink |
|---|---|---|
| 412C | C | B |
| 408A | C | A |
| 408B | B | A |
| 408E | B | C |
| 408D | A | B |
| 408F | A | C |

In this example, the first listed connection arc in Table II, i.e., connection arc 412C (FIG. 4) between source 404C and sink 404B, has the highest priority because this connection arc has the largest minimum timing margin value, here 2. The second listed connection arc in Table II, i.e., connection arc 408A between source C and sink A, has the next highest priority because this connection arc has one of the next largest minimum timing margin value, i.e., −1. It is recognized that any one of connection arcs 408A, 408B, 408E could be listed second, third, and fourth in Table II because they all have the same minimum timing margin value of −1. The ordering of connection arcs 408A, 408B, 408E may be arbitrary or may be based on one or more other criteria, such as physical distance between the corresponding respective sources and sinks and the ordering from the corresponding ordered connectivity list, among others.

Once the connectivity priority order and/or timing priority orders have been determined, respectively, at steps 324, 328, method 300 may proceed to step 332 at which design partitions 312 are sorted. This step 332 may include applying one or more weights to the sorted partitions 312. For example, if only a connectivity ordering was performed or if only a timing ordering was performed, then a weight of 1 may be applied to the sorted partitions 312. However, if both orderings were performed, each ordering may be weighted with a selected weight that produces a desired clock system design. Such weights may be applied according to the equation CWeight*CP+TWeight*TP, wherein CWeight is a selected weight for the connectivity-based ordering, CP is the connectivity priority, TWeight is a selected weight for the timing-based ordering, and TP is the timing priority. CWeight and TWeight may be values pre-selected and unchangeable for a particular instantiation of method 300 or, alternatively, may be changeable, for example, by a user of software implementing the method.

Once the connectivity arcs have been ordered and/or weighted, at step 336, a clock circuit design, such as the design of clock circuit 104 of FIG. 1, is generated so as to contain as many interleaved clock signals (e.g., clock signals 108A-C) as there are design partitions (e.g., design partitions 112A-C). In one example, the interleaved clock signals are determined by dividing the period of the clock by the number of design partitions (e.g., design partitions 112A-C). In another example, the interleaved clock signals are determined by selecting a constant value and offsetting the clock signal for each design partition (e.g., design partitions 112A-C) by that constant value. It is permissible, however, that the first design partition may have an offset value equal to zero.

Various functions of a method of designing a clock circuitry, such as method 300 of FIG. 3, can be implemented in software that can be stored on any suitable machine-readable memory(ies), including electronic storage media (such as RAMs, ROMs, flash memories), optical storage media (such as CDs, DVDs, BDs (i.e., Blu-Ray disks), holographic disks, etc.), magnetic storage media (hard disks, floppy disks, tapes, etc.), among others. As those skilled in the art will readily appreciate, a method of the present disclosure may be implemented in any of a wide variety of ways, depending on the type of environment in which the software is designed to be run. Since the various environments and ways of implementing software in these environments are well known, it is not necessary to provide any examples herein for skilled artisans to appreciate the broad scope of the present disclosure.

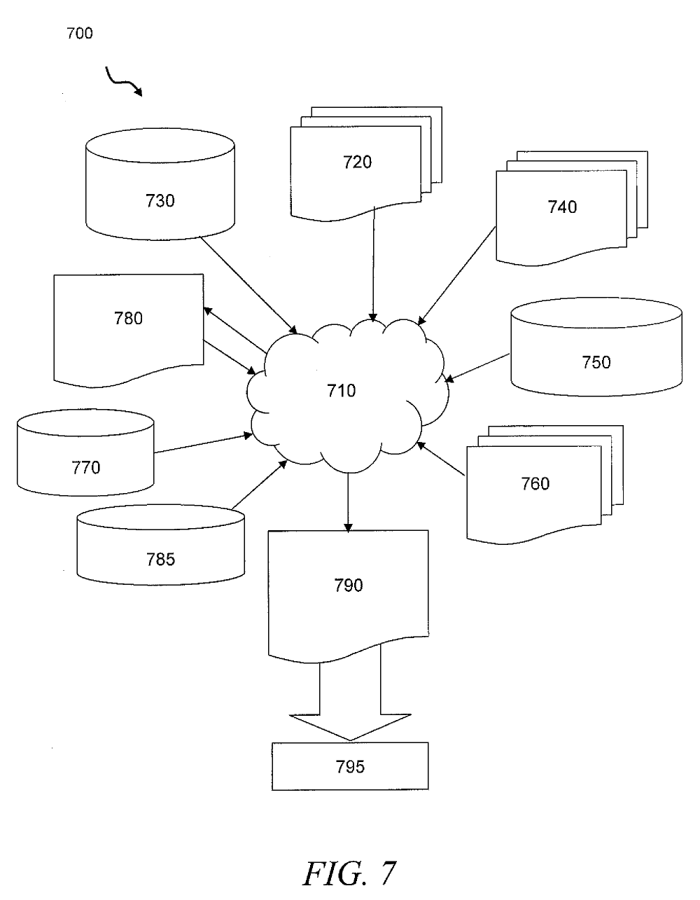

FIG. 7 shows a block diagram of an example design flow 700. Design flow 700 may vary depending on the type of IC being designed. For example, a design flow 700 for building an application specific IC (ASIC) may differ from a design flow 700 for designing a standard component. Design structure 720 is preferably an input to a design process 710 and may come from an IP provider, a core developer, or other design company or may be generated by the operator of the design flow, or from other sources. Design structure 720 comprises circuit system 100 in the form of schematics or HDL, a hardware-description language (e.g., Verilog, VHDL, C, etc.). Design structure 720 may be contained on one or more machine readable medium. For example, design structure 720 may be a text file or a graphical representation of circuit system 100. Design process 710 preferably synthesizes (or translates) circuit system 100 into a netlist 780, where netlist 780 is, for example, a list of wires, transistors, logic gates, control circuits, I/O, models, etc. that describes the connections to other elements and circuits in an integrated circuit design and recorded on at least one of machine readable medium. This may be an iterative process in which netlist 780 is resynthesized one or more times depending on design specifications and parameters for the circuit.

Design process 710 may include using a variety of inputs; for example, inputs from library elements 730 which may house a set of commonly used elements, circuits, and devices, including models, layouts, and symbolic representations, for a given manufacturing technology (e.g., different technology nodes, 32 nm, 45 nm, 90 nm, etc.), design specifications 740, characterization data 750, verification data 760, design rules 770, and test data files 785 (which may include test patterns and other testing information). Design process 710 may further include, for example, standard circuit design processes such as timing analysis, verification, design rule checking, place and route operations, etc. One of ordinary skill in the art of integrated circuit design can appreciate the extent of possible electronic design automation tools and applications used in design process 710 without deviating from the scope and spirit of the invention. The design structure of the invention is not limited to any specific design flow.

Design process 710 preferably translates an embodiment of the invention as shown in FIG. 1, along with any additional integrated circuit design or data (if applicable), into a second design structure 790. Design structure 790 resides on a storage medium in a data format used for the exchange of layout data of integrated circuits (e.g. information stored in a GDSII (GDS2), GL1, OASIS, or any other suitable format for storing such design structures). Design structure 790 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIG. 1. Design structure 790 may then proceed to a stage 795 where, for example, design structure 790: proceeds to tape-out, is released to manufacturing, is released to a mask house, is sent to another design house, is sent back to the customer, etc.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A design structure embodied in a machine readable medium used in a design process for an integrated circuit system, the design structure comprising:
a plurality of functional blocks distributed among a plurality of design partitions and interconnected by a plurality of connection arcs; and
a clock system, comprising:
clock interleaving circuitry for interleaving a plurality of clock signals corresponding respectively to said plurality of design partitions, said clock interleaving circuitry configured as a function of a connectivity model of said plurality of connecting arcs or a timing model of said plurality of connecting arcs or both of said connectivity model and said timing model; and
a plurality of timing paths connected to ones of said plurality of functional blocks in each of said plurality of design partitions so as to provide said plurality of clock signals to said plurality of functional blocks.

2. The design structure, according to claim 1, wherein the design structure comprises a netlist, which describes the circuit.

3. The design structure according to claim 1, wherein the design structure resides on storage medium as a data format used for the exchange of layout data of integrated circuits.

4. The design structure, according to claim 1, wherein the design structure includes at least one of test data files, characterization data, verification data, or design specifications.
